(19) United States
(12) Patent Application Publication
(10) Pub. No.: US 2005/0228079 A1
(43) Pub. Date: Oct. 13, 2005

(54) Thermosetting resin composition and adhesive films

(76) Inventors: Toru Fujiki, Tsukuba-shi (JP); Toshiki Mori, Tsukuba-shi (JP); Hironobu Iyama, Tsukuba-shi (JP); Shigeki Naitoh, Tsukuba-shi (JP)

Correspondence Address: BIRCH STEWART KOLASCH & BIRCH, PO BOX 747, FALLS CHURCH, VA, 22040-0747, US

(21) Appl. No.: 10/509,023

(22) PCT Filed: Mar. 26, 2003
(86) PCT No.: PCT/JP03/03702

§ 371 Date: Nov. 29, 2004

(30) Foreign Application Priority Data
Mar. 28, 2002 (JP) 2002-90986
Jul. 2, 2002 (JP) 2002-193077
Aug. 30, 2002 (JP) 2002-253217

(51) Int. Cl. C08L 63/00

(52) U.S. Cl. 523/402; 523/451; 523/453

(57) ABSTRACT

The present invention provides a thermosetting resin composition containing the following (A) component and (B) component, an adhesive containing the thermosetting resin composition and an organic solvent and/or water, and an adhesive film containing the thermosetting resin composition. (A) component: at least one kind of phenol resin selected from the group consisting of alkylphenol novolak, a phenol adduct of an aliphatic polymer containing a double bond, and a phenol adduct of an alicyclic polymer containing a double bond
(B) component: epoxy group—containing ethylene-based copolymer obtained by polymerizing the following (b₁) and (b₂):
(b₁) ethylene and/or propylene
(b₂) monomer represented by the following formula (1): 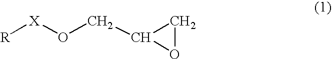 (wherein R represents a hydrocarbon group of a carbon number of 2 to 18 having a double bond, wherein at least one of hydrogen atoms of the hydrocarbon group may be substituted with a halogen atom, a hydroxyl group or a carboxyl group, and X represents a single bond or a carbonyl group).

### FIELD OF THE INVENTION

The present invention relate to a thermosetting resin composition comprising a phenol resin, and an epoxy group-containing ethylene-based copolymer, an adhesive film obtained from the composition, and a laminate obtained by laminating the adhesive film and an adherend, and a laminate obtained by thermally curing this.

### BACKGROUND ART

In recent years, in the field of electric and electronic parts, thinning and down-sizing are being progressed, semiconductor sealing materials, electronic part sealing materials for solar cells and EL (electroluminescence) lamps, die bonding sheets between integrated circuit/substrate, and electric and electronic part adhesives for an interlayer insulating layer between substrates require low elastic modulus and a reduced film in addition to heat resistance to solder (hereinafter, referred to as solder heat resistance). And, in order to simplify a procedure of manufacturing electric and electronic parts, dry film-like form is required as a form before curing of an adhesive.

On the other hand, JP-A No.53-126053 discloses that a thermosetting resin composition obtained by mixing an epoxy group-containing ethylene copolymer into phenol novolak obtained from formaldehyde and phenol without alkyl group provides a cured article which is tough to fragile breakage.

The present inventors used phenol novolak obtained from formaldehyde and phenol without alkyl group, mixed this with an epoxy group-containing ethylene copolymer to obtain a composition, dissolved the composition in an organic solvent, coated the solution on a support substrate, and dried to obtain an adhesive film, and studied the obtained adhesive film. And, it was found out that the adhesive film is opaque, and has not sufficient film processability. In addition, the present inventors laminated the adhesive film and an electric or electronic part as an adherend, and thermally cured them to adhere, and the resulting laminate was found to have insufficient solder heat resistance.

### DISCLOSURE OF THE INVENTION

An object of the present invention is to provide a thermosetting resin composition which gives an adhesive film excellent in film processability and solder heat resistance.

The present inventors found out that a thermosetting resin composition containing a specified phenol resin and an epoxy group-containing ethylene copolymer can achieve such the object.

That is, the present invention relates to the following inventions:
<1> A thermosetting resin composition comprising the following (A) component and (B) component.

(A) component: at least one kind of a phenol resin selected from the group consisting of alkylphenol novolak, a phenol adduct of an aliphatic polymer containing a double bond, and a phenol adduct of an alicyclic polymer containing a double bond

(B) component: an epoxy group-containing ethylene copolymer obtained by polymerizing the following (b₁) and (b₂):
(b₁) ethylene and/or propylene
(b₂) a monomer represented by the formula (1): 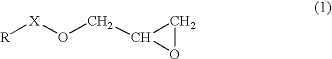
   (wherein R represents a hydrocarbon group of a carbon number of from 2 to 18 having a double bond, wherein at least one of hydrogen atoms of the hydrocarbon group may be substituted with a halogen atom, a hydroxyl group or a carboxyl group, and X represents a single bond or a carbonyl group.)

<2> The thermosetting resin composition according to <1>, wherein the alkylphenol novolak is a condensate of phenol substituted with an alkyl group of a carbon number of from 2 to 20 and formalin.

<3> The thermosetting resin composition according to <1>or <2>, wherein a content of a structural unit derived from (b₂) is 1 to 30 parts by weight relative to 100 parts by weight of the (B) component.

<4> The thermosetting resin composition according to any one of <1> to <3>, wherein the (B) component is a copolymer obtained by polymerizing (b₁), (b₂) and the following (b₃):
(b₃): a monomer which has a functional group copolymerizable with ethylene, does not have a functional group reactive with an epoxy group, and is different from either of (b₁) and (b₂).

<5> The thermosetting resin composition according to any one of <1> to <4>, wherein a content of a structural unit derived from (b₁) is 30 to 75 parts by weight relative to 100 parts by weight of the (B) component.

<6> The thermosetting resin composition according to any one of <1> to <5>, wherein a weight ratio of the (A) component and the (B) component is (A)/(B)=4/96 to 50/50.

<7> The thermosetting resin composition according to any one of <1> to <6>, which further contains a (C) component:

(C) component: an antioxidant.

<8> The thermosetting resin composition according to <7>, wherein the (C) component is at least one kind of an antioxidant selected from the group consisting of a phenolic antioxidant, a phosphoric antioxidant, and a sulfuric antioxidant.

<9> An adhesive, which comprises the thermosetting resin composition according to any one of <1> to <8> and the following (D) component:

(D) component: organic solvent and/or water.

<10> The adhesive according to <9>, wherein a total weight of the (A) component and (B) component is 10 to 150 parts by weight relative to 100 parts by weight of the (D) component.

<11> An adhesive film, which comprises the thermosetting resin composition according to any one of <1> to <8>.

<12> The adhesive film according to <11>, which is obtained by coating the adhesive according to <9> or <10> on a support substrate, and drying this.

<13> The adhesive film according to <11>, which is obtainable by extrusion molding.

<14> An adhesive film, which is obtainable by further irradiating the adhesive film according to any one of <11> to <13> with an electron beam.

<15> The adhesive film according to <14>, which is obtainable by performing electron beam irradiation plural times.

<16> A laminate, which is obtainable by laminating the adhesive film according to any one of <11> to <15> and an adherend, and thermally curing this.

### BEST MODE FOR CARRYING OUT THE INVENTION

The thermosetting resin composition of the present invention (hereinafter, referred to as present composition) is characterized in that it contains the aforementioned (A) component and (B) component.

The (A) component used in the present invention is at least one of a phenol resin selected from the group consisting of alkylphenol novolak, a phenol adduct of an aliphatic polymer containing a double bond, and a phenol adduct of an alicyclic polymer containing a double bond.

Herein, the alkylphenol novolak is a condensate of phenol in which at least one of hydrogen atoms bound to phenol is substituted with an alkyl group of a carbon number of from 2 to 20, so-called alkylphenol, and aldehyde of a carbon number of from 1 to about 4.

Examples of the alkyl-group include a straight-chain alkyl group, a branched alkyl group, and an alicyclic alkyl group, and specific examples include a straight-chain alkyl group such as an ethyl group, a n-propyl group, a n-butyl group, a n-pentyl group, a n-octyl group, a n-nonyl group, a n-decyl group, a n-undecanyl group, a n-octadecyl group, and a n-dodecyl group; a branched alkyl group such as an isopropyl group, a t-butyl group, and an ethylhexyl group; an alicyclic alkyl group such as a cyclopentyl group and a cyclohexyl group.

As the alkyl group, inter alia, an alkyl group of a carbon number of around 4 to 18 is preferable.

The number of alkyl groups in the alkylphenol is usually 1 to 2, preferably 1.

Examples of the aldehyde of a carbon number of from 1 to about 4 include formaldehyde, acetaldehyde, n-butylaldehyde, glyoxal, glutaraldehyde, glyoxylic acid, and paraformaldehyde. Inter alia, formaldehyde, acetaldehyde, and paraformaldehyde are preferable, particularly formaldehyde is preferable.

As far as an entity derived from the (A) component and an entity derived from the (B) component show compatibility (are not separated) in a cured article finally obtained using the present composition, the alkylphenol novolak may contain a non-substituted phenol group, but it is preferable that phenol novolak does not substantially contain a non-substituted phenol group.

The alkylphenol novolak contains usually phenol novolak having about 2 to 5 structural units derived from alkylphenol, as a main component.

The alkylphenol novolak is commercially available, and such the alkylphenol novolak can be used. Examples of the commercially available alkylphenol novolak include “Hitanol 1501 (registered trade mark)” (manufactured by Hitachi Chemical Co., Ltd.), “Tackrol 101 (registered trade mark)” (manufactured by Taoka Chemical Co., Ltd.) and “Tamanol 7508 (registered trade mark)” (manufactured by Arakawa Chemical Industries, Ltd.).

The phenol adduct of an aliphatic polymer containing a double bond is such that an aliphatic polymer containing a double bond such as a homopolymer of a conjugated diene compound such as polybutadiene, and a copolymer of α-olefin and a conjugated diene compound, is reacted with phenols such as phenol, cresol, resorcin, and the aforementioned alkylphenol. As phenols, inter alia, phenol is preferable.

As the phenol adduct of an aliphatic polymer containing a double bond, for example, Nisseki special phenol resin “PP” series (manufactured by Nippon Petrochemicals Co., Ltd.), Nisseki special phenol resin “DPP” series (manufactured by Nippon Petro chemicals Co., Ltd.), and Nisseki special phenol resin “DPA” series (manufactured by Nippon Petrochemicals Co., Ltd.) are commercially available, and such the commercially available adducts can be used.

The phenol adduct of an alicyclic polymer containing a double bond is such that an alicyclic polymer containing a double bond such as a terpene resin, for example sesquiterpene, is reacted with phenols. As phenols to be added, phenol is preferable.

As the phenol adduct of an alicyclic polymer containing a double bond, for example, “YP-90LL” (manufactured by Yasuhara Chemical Co., Ltd.) is commercially available, and such the commercially available adducts can be used.

The phenol adduct of an alicyclic polymer containing a double bond includes also adducts obtained by reacting a mixture of polybutadiene and a terpene resin with phenols.

The (B) component used in the present invention is an epoxy group-containing ethylene copolymer obtained by polymerizing (b₁) ethylene and/or propylene (hereinafter, referred to as (b₁) monomer) and (b₂) a monomer represented by the following formula (1): 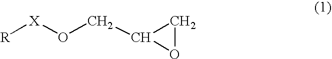
(wherein R represents a hydrocarbon group of a carbon number of from 2 to 18 having a double bond, wherein at least one of hydrogen atoms of the hydrocarbon group may be substituted with a halogen atom, a hydroxyl group or a carboxyl group and X represents a single bond or a carbonyl group) (hereinafter, referred to as (b₂) monomer).

Inter alia, as the (b₁) monomer, ethylene is preferable.

As the substituent R in the formula (1), for example, there are substituents of the following formulas (2) to (8):

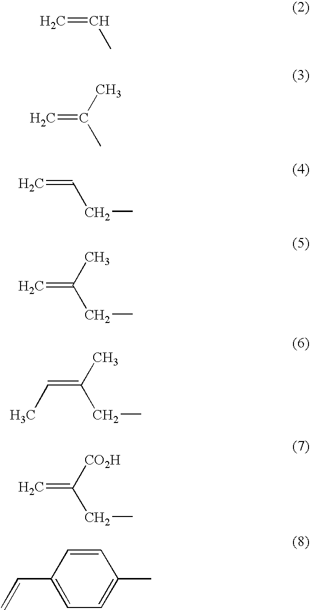

In addition, X in the formula (1) represents a single bond in which an oxygen atom and a substituent R are directly bound in the formula (1), or a carbonyl group.

Specific examples of the (b₂) monomer include unsaturated glycidyl ether such as allyl glycidyl ether, 2-methylallyglycidyl ether, and styrene-p-glycidyl ether and unsaturated glycidyl esters such as glycidyl acrylate, glycidyl methacrylate and itaconic acid glycidyl ester.

A content of a structural unit derived from the (b₂) monomer is usually about 1 to about 30 parts by weight relative to 100 parts by weight of the (B) component. When a structural unit derived from the (b₂) monomer exceeds 1 part by weight, there is a tendency that adherability of the resulting adhesive film is improved, being preferable. When the structural unit is below 30 parts by weight, there is a tendency that a mechanical strength of an adhesive film is improved, being preferable.

In addition, a content of a structural unit derived from (b₁) is preferably about 30 to about 99 parts by weight relative to 100 parts by weight of the (B) component.

For example, by polymerizing a monomer which is different from either of a (b₁) monomer and a (b₂) monomer, and has a functional group copolymerizable with ethylene such as a vinyl group and an alkylene group (hereinafter, referred to as (b₃) monomer) in addition to the (b₁) monomer and the (b₂) monomer, the (B) component may contain a structural unit derived from the (b₃) monomer in addition to a structural unit derived from the (b₁) monomer and a structural unit derived from the (b₂) monomer. The (b₃) monomer must not substantially contain a functional group which can be reacted with an epoxy group, such as a carboxyl group (—COOH) or an acid anhydride group (—CO—O—CO—), but since an ester group does not react with an epoxy group, this may be contained.

Specific examples of the (b₃) monomer include α,β-unsaturated carboxylic acid alkyl esters having an alkyl group of a carbon number of about 3 to about 8 such as methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate and isobutyl methacrylate; vinyl esters of carboxylic acid of a carbon number of about 2 to about 8 such as vinyl acetate, vinyl butyrate, vinyl propionate, vinyl pivalate, vinyl laurate, vinyl isononanate, and vinyl versatate; α-olefins of a carbon number of about 4 to about 20 such as 1-butene and isobutene; diene compounds of a carbon number of about 3 to about 20 such as butadiene, isoprene and cyclopentadiene; vinyl compounds of a carbon umber of about 2 to about 20 such as vinyl chloride, styrene, acrylonitrile, methacrylonitrile, acrylamide, and methacrylamide.

As the (b₃) monomer, inter alia, vinyl acetate, methyl acrylate, ethyl acrylate, n-butyl acrylate, and methyl methacrylate are preferable.

A content of a structural unit derived from the (b₃) monomer is usually about 0 to about 70 parts by weight relative to 100 parts by weight of the (B) component and, inter alia, about 5 to about 60 parts by weight is preferable. When this content is 70 parts by weight or smaller, there is a tendency that the (B) component can be easily prepared by a high pressure radical method, being preferable.

The (B) component may be any of a block copolymer, a graft copolymer, a random copolymer, and an alternating copolymer. Examples thereof include a copolymer obtained by grafting a propylene-ethylene block copolymer with (b₂) described in Japanese Patent No.2632980 (corresponding to U.S. Pat. No. 5,032,459), and a copolymer obtained by grafting an ethylene.epoxy group-containing monomer copolymer with α,β-unsaturated carboxylic acid ester described in Japanese Patent No. 2600248.

Examples of a process for preparing the (B) component in the present invention include a method of copolymerizing a monomer as a raw material at about 500 to about 4000 atm and about 100 to about 300° C. in the presence of ethylene and a radical generator, and in the presence or the absence of proper solvent or chain transfer agent; a method of mixing a monomer such as the (b₂) monomer as a raw material and a radical generator into a polyethylene resin, and melt graft-copolymerizing the mixture in an extruder. Herein, a polyethylene resin includes a homopolymer of (b₁), and a copolymer of (b₃) and (b₁).

The (B) component in the present invention is preferable that MFR (melt flow rate) measured according to JIS K7210 is usually about 30 to about 1000 g/10 minutes, preferably about 50 to about 500 g/10 minutes at 190° C. under condition of 2.16 kg load. When MFR is 30 or larger, there is a tendency that flowability of the resulting thermosetting resin composition is improved and, even when there are irregularities on a surface of an adherend, they are easily embedded, being preferable. On the other hand, when MFR is 1000 or smaller, there is a tendency that solder heat resistance of the resulting thermosetting resin composition is improved, being preferable.

The (B) component is commercially available and, for example, those which are commercially available such a “Bondfast (registered trade mark)” series (manufactured by Sumitomo Chemical Co., Ltd.), “Sepolsion G (registered trademark)” series (manufactured by Sumitomo Seika Chemicals Co., Ltd.), and “Rexpearl RA (registered trade mark)” series (manufactured by Nippon Polyolefin (K.K.)) can be used.

The thermosetting resin composition of the present invention is such that the (A) component and the (B) component are mixed, and the thermosetting resin composition is usually such that the (A) component and the (B) component are compatibilized.

A weight ratio of the (A) component and the (B) component in the thermosetting resin composition is usually around (A)/(B)=4/96 to 50/50.

In addition, the thermosetting resin composition may contain a promoter for curing an epoxy resin such as an amine compound, imidazoles, and an organic phosphorus compound in order to promote a curing reaction of the (A) and (B) components.

By inclusion of an antioxidant as a (C) component in addition to the (A) component and the (B) component in the thermosetting resin composition of the present invention, there is a tendency that, when the composition is molded into a film, occurrence of ununiform foreign matter called “fish eye” is suppressed, and storage stability of the composition and an adhesive film obtained from the composition is improved and, therefore, the (C) component is preferably contained.

Examples of the (C) component include a phenolic antioxidant, a phosphoric antioxidant, a sulfuric antioxidant, and an amine antioxidant. As the antioxidant, two or more kinds of antioxidants may be used by combining them. Inter alia, from a viewpoint of gel preventing effect and coloring, it is preferable to use any of a phenolic antioxidant, a phosphoric antioxidant and a sulfuric antioxidant.

Examples of the phenolic antioxidant include
2,6-di-t-butyl-4-methylphenol, 2,6-di-t-butyl-4-ethylphenol,
2,6-dicyclohexyl-4-methylphenol,
2,6-di-t-amyl-4-methylphenol,
2,6-di-t-octyl-4-n-propylphenol,
2,6-dicyclohexyl-4-n-octylphenol,
2-isopropyl-4-methyl-6-t-butylphenol,
2-t-butyl-2-ethyl-6-t-octylphenol,
2-isobutyl-4-ethyl-6-t-hexylphenol,
2-cyclohexyl-4-n-butyl-6-isopropylphenol, d1-α-tocopherol, t-butylhydroquinone,
2,2′-methylenebis(4-methyl-6-t-butylphenol),
4,4′-butylidenebis(3-methyl-6-t-butylphenol),
4,4′-thiobis(3-methyl-6-t-butylphenol),
2,2′-thiobis(4-methyl-6-t-butylphenol),
4,4′-methylenebis(2,6-di-t-butylphenol),
2,2′-methylenebis[6-(1-methylcyclohexyl)-p-cresol],
2,2′-ethylidenebis(4,6-di-t-butylphenol),
2,2′-butylidenebis(2-t-butyl-4-methylphenol),
2-t-butyl-6-(3-t-butyl-2-hydroxy-5-methylbenzyl)-4-methylphenyl acrylate,
2-[1-(2-hydroxy-3,5-di-t-pentylphenyl)ethyl]-4,6-di-t-pentylphenylacrylate,
1,1,3-tris(2-methyl-4-hydroxy-5-t-butylphenyl)butane, triethylene glycol
bis[3-(3-t-butyl-5-methyl-4-hydroxyphenyl)propionate], 1,6-hexanediol
bis[3-(3,5-di-t-butyl-4-hydroxyphenyl)propionate],
2,2-thiodiethylenebis[3-(3,5-di-t-butyl-4-hydroxyphenyl)propionate],
N,N′-hexamethylenebis(3,5-di-t-butyl-4-hydroxy-hydrocinnamide), 3,5-di-t-butyl-4-hydroxybenzylphosphonate diethyl ester,
tris(2,6-dimethyl-3-hydroxy-4-t-butylbenzyl) isocyanurate,
tris(3,5-di-t-butyl-4-hydroxybenzyl) isocyanurate, tris[(3,5-di-t-butyl-4-hydroxyphenyl)propionyloxyethyl] isocyanurate, tris(4-t-butyl-2,6-dimethyl-3-hydroxybenzyl) isocyanurate,
2,4-bis(n-octylthio)-6-(4-hydroxy-3,5-di-t-butylanilino)-1, 3,5-triazine,
tetrakis[methylene-3-(3,5-di-t-butyl-4-hydroxyphenyl)propionate]methane, 2,2′-methylenebis(4-methyl-6-t-butylphenol) terephthalate,
1,3,5-trimethyl-2,4,6-tris(3,5-di-t-butyl-4-hydroxybenzyl)benzene,
3,9-bis[1,1-dimethyl-2-{β-(3-t-butyl-4-hydroxy-5-methylphenyl)propionyloxy)ethyl]-2,4,8,10-tetraoxaspiro[5,5]undecane,
2,2-bis[4-(2-(3,5-di-t-butyl-4-hydroxyhydrocinnamoyloxy))ethoxyphenyl]propane, and
β-(3,5-di-t-butyl-4-hydroxyphenyl)propionic acid stearyl ether.

Among them,
β-(3,5-di-t-butyl-4-hydroxyphenyl)propionic acid stearyl ester,
tetrakis[methylene-3-(3,5-di-t-butyl-4-hydroxyphenyl)propionate]methane, tris(3,5-di-t-butyl-4-hydroxybenzyl) isocyanurate,
1,3,5-trimethyl-2,4,6-tris(3,5-di-t-butyl-4-hydroxybenzyl)benzene, d1-α-tocopherol,
tris(2,6-dimethyl-3-hydroxy-4-t-butylbenzyl) isocyanurate,
tris[(3,5-di-t-butyl-4-hydroxyphenyl)propionyloxyethyl]isocyanurate, and
3,9-bis[1,1-dimethyl-2-{β-(3-t-butyl-4-hydroxy-5-methylphenyl)propionyloxy}ethyl]-2,4,8,10-tetraoxaspiro[5,5]undecane are preferable.

As the phenolic antioxidant, commercially available phenolic antioxidants may be used, and examples of such the commercially available phenolic antioxidants include Irganox 1010 (manufactured by Ciba Specialty Chemicals), Irganox 1076 (manufactured by Chiba Specialty Chemicals), Irganox 1330 (manufactured by Chiba Specialty Chemicals), Irganox 3114 (manufactured by Chiba Specialty Chemicals), Irganox 3125 (manufactured by Chiba Specialty Chemicals), Sumilizer BHT (manufactured by Sumitomo Chemical Co., Ltd.), Cyanox 1790 (manufactured by Cytech), Sumilizer GA-80 (manufactured by Sumitomo Chemical Co., Ltd.), and vitamin E (manufactured by Esai).

As the phenolic antioxidant, two or more of phenolic antioxidants may be used.

Examples of the phosphoric antioxidant include trioctyl phosphite, trilauryl phosphite, tridecyl phosphite, (octyl)diphenyl phosphite, tris(2,4-di-t-butylphenyl) phosphite, triphenyl phosphite, tris(butoxyethyl) phosphite, tris(nonylphenyl) phosphite, distearylpentaerythritol diphosphite,
tetra(tridecyl)-1,1,3-tris(2-methyl-5-t-butyl-4-hydroxyphenyl)butane diphosphite, tetra(C₁₂˜C₁₅ mixed alkyl)-4,4′-isopropylidenediphenyl diphosphite,
tetra(tridecyl)-4,4′-butylidenebis(3-methyl-6-t-butylphenol)diphosphite, tris(3,5-di-t-butyl-4-hydroxyphenyl) phosphite, tris(mono-di-mixed nonylphenyl) phosphite, hydrogenated-4,4′-isopropylidenediphenol polyphosphite, bis(octylphenyl)bis[4,4′-butylidenebis(3-methyl-6-t-butylphenol)]-1,6-hexanediol diphosphite,
phenyl(4,4′-isopropylidenediphenol)pentaerythritol diphosphite, distearylpentaerythritol diphosphite, tris[4,4′-isopropylidenebis(2-t-butylphenol)] phosphate, di(isodecyl)phenyl phosphate,
4,4′-isopropylidenebis(2-t-butylphenol)bis(nonylphenyl) phosphate,
9,10-dihydro-9-oxa-10-phosphaphenanthrene-10-oxide, bis(2,4-di-t-butyl-6-methylphenyl)ethyl phosphate,
2-[(2,4,8,10-tetra-t-butyldibenz[d,f][1.3.2]-dioxaphosphepin-6-yl)oxy]-N,N-bis[2-[{2,4,8,10-tetra-t-butyldibenz[d,f][1.3.2)-dioxaphosphepine-6-yl}oxy]ethyl]ethaneamine,
6-[3-(3-t-butyl-4-hydroxy-5-methylphenyl)propoxy]-2,4,8,10-tetra-t-butyldibenz[d,f][1.3.2]-dioxaphosphepine.

In addition, examples of
bis(dialkylphenyl)pentaerythritol diphosphite ether include a spiro-type compound represented by the following formula (9): 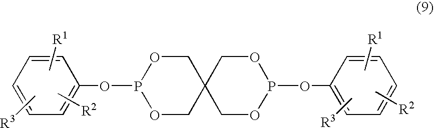
   (wherein R¹, R²and R³ represent independently a hydrogen atom or an alkyl group of a carbon number of from 1 to about 9), and a cage-type compound represented by the following formula (10) 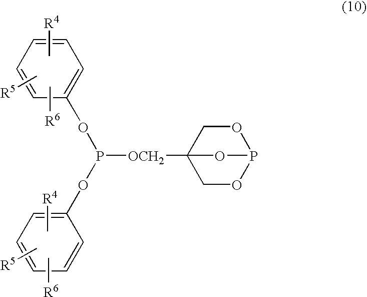
   (wherein R⁴, R⁵ and R⁶ represent independently a hydrogen atom or an alkyl group of a carbon number of from 1 to about 9).

As such the phosphite ester, usually, a mixture of the formulas (9) and (10) is used.

When R¹ to R⁶ are an alkyl group, a branched alkyl group is preferable and, inter alia, a t-butyl group is preferable.

In addition, as a position of substitution of R¹ to R⁶ in a phenyl group, 2, 4 and 6 positions are preferable.

Specific examples of phosphite ester include bis(2,4-di-t-butylphenyl)pentaerythritol diphosphite, bis(2,6-di-t-butyl-4-methylphenyl)pentaerythritol diphosphite, and bis(nonylphenyl)pentaerythitol diphosphite. In addition, examples of phosphonite having a structure in which carbon and phosphorus are directly bound include a compound such as
tetrakis(2,4-di-t-butylphenyl)-4,4′-biphenylenediphosphonite.

As the phosphoric antioxidant, commercially available phosphoric antioxidants maybe used, and examples include Irgafos 168 (manufactured by Chiba Specialty Chemicals), Irgafos 12 (manufactured by Chiba Specialty Chemicals), Irgafos 38 (manufactured by Chiba Specialty Chemicals), ADK STAB 329K (manufactured by Asahi Denka Kogyo K.K.), ADK STAB PEP 36 (manufactured by Asahi Denka Kogyo K.K.), ADK STAB PEP-8 (manufactured by Asahi Denka Kogyo K.K.), Sandstab P-EPQ (manufactured by Clariant), Weston 618 (manufactured by GE), Weston 619G (manufactured by GE), Ultranox 626 (manufactured by GE), and Sumilizer GP (manufactured by Sumitomo Chemical Co., Ltd.).

As the phosphoric antioxidant, two or more kinds of phosphoric antioxidants may be used.

Among phosphoric antioxidants, tris(2,4-di-t-butylphenyl) phosphite, tetrakis(2,4-di-t-butylphenyl)-4,4′-biphenylene diphosphanite, distearylpentaerythritol diphosphite, bis(2,4-di-t-butylphenyl)pentaerythritol diphosphite, 2-[{2,4,8,10-tetra-t-butyldibenz[d,f][1.3.2]-dioxaphosphepin-6-yl}oxy]-N,N-bis[2-[(2,4,8,10-tetra-t-butyldibenz[d,f][1.3.2]-dioxaphosphepine-6-yl}oxy]ethyl]ethaneamine, and 6-[3-(3-t-butyl-4-hydroxy-5-methylphenyl)propoxy]-2,4,8,10-tetra-t-butyldibenz[d,f][1.3.2]-dioxaphosphepine are preferable.

Examples of the sulfuric antioxidant include esters of polyhydric alcohols (e.g. glycerin, trimethylolethane, trimethylolpropane, pentaerythritol, trishydroxyethyl isocyanurate) of dialkylthiodipropionate such as dilauryl-, dimyristyl- and distearyl-, and alkylthiopropionic acid such as butyl-, octyl-, rauryl-, and stearyl- (e.g. pentaerythryltetrakis-3-laurylthiopropionate).

Further specific examples include dilauryl thiodipropionate, dimyristyl thiodipropionate, distearyl thiodipropionate, laurylstearyl thiodipropionate, and distearyl thiodibutyrate. Among them, pentaerythryltetrakis-3-lauryl thiopropionate is preferable.

As the sulfuric antioxidant, commercially available sulfuric antioxidants maybe used, and examples include Sumilizer TPS (manufactured by Sumitomo Chemical Co., Ltd.), Sumilizer TPL-R (manufactured by Sumitomo Chemical Co., Ltd.), Sumilizer TPM (manufactured by Sumitomo Chemical Co., Ltd.), and Sumilizer TP-D (manufactured by Sumitomo Chemical Co., Ltd.).

AS the sulfuric antioxidant, two or more kinds of sulfuric antioxidants may be used.

Examples of the amine antioxidant include a polymer of 2,2,4-trimethyl-1,2-dihydroquinoline, 6-ethoxy-2,2,4-trimethyl-1,2-dihydroquinoline, N-(1,3-dimethylbutyl)-N′-phenyl-1,4-phenylenediamine, and N-isopropyl-N′-phenyl-1,4-phenylenediamine.

An amount of the (C) component to be blended in the present composition is usually from about 0.005 to about 2 parts by weight, preferably about from 0.01 to about 1 part by weight, further preferably from about 0.05 to about 0.5 part by weight relative to 100 parts by weight of the (A) component.

The present composition contains the aforementioned (A) component and (B) component, and examples of a process for preparing the composition include a method of melting and kneading the (A) component usually at around 120° C. to 200° C. with a monoaxial or a biaxial screw extruder, a Banbury mixer, a roll or various kneaders, and mixing this with the (B) component; a method of dry-blending the (A) component and the (B) component, and melting and kneading the blend usually at around 120° C. to 150° C. with a monoaxial or biaxial screw extruder, a Banbury mixer, a roll or various kneaders. Herein, when the (B) component is massive, by mixing after converted into a powder with a grinder such as a feather mill, a Nara-type grinder, and an air mill, melting and kneading are simplified, being preferable.

In addition, when the present composition containing the (C) component is prepared, it is preferable that the (C) component and the (A) component are both melted and kneaded.

Further, additives such as a coloring agent, an inorganic filler, a processing stabilizer, a weather resistant agent, a thermal stabilizer, an optical stabilizer, a nucleating agent, a lubricant, a releasing agent, a flame-retardant, and an antistatic agent may be contained in the present composition.

When the present composition is utilized in a solder resist, in order to mask a conductive circuit on a surface of a printed circuit board, a dye and a pigment such as phthalocyanine green and carbon black are usually used as a coloring agent.

The adhesive film of the present invention (hereinafter, referred to as present adhesive film) is such that the present composition is in a form of a thin layered (film-like) form, and examples of a process for preparing the same include (I) a method of extruding and molding the present composition into film-like with a T die extruder or the like, (II) a method of extruding and molding the present composition into film-like on a support substrate with a T die extruder or the like, (III) a method of laminating the film obtained in (I) on a support substrate, (IV) a method of coating an adhesive obtained by dissolving or dispersing the present composition in an organic solvent and/or water (hereinafter, referred to as present adhesive) on an adherend like a paint, and drying this, and (V) a method of coating the present adhesive on a support substrate, and drying this. Inter alia, for electric and electronic parts, the present adhesive film obtained in (II) or (V) is preferable.

Herein, a process for preparing a film obtained by extrusion molding (e.g. the process of the above (I) and (II)) will be further explained. A distance between a T-die and a chill roll (air gap) is usually about 10 cm or smaller, preferably about 8 cm or smaller, particularly preferably about 6 cm or smaller. When an air gap is 10 cm or smaller, there is a tendency that film breakage and state where a thickness of a film varies generally called “one side thick” are suppressed, being preferable.

In a method by extrusion molding, the present composition is melted and kneaded, and extruded and molded, and a melting and kneading temperature is preferably not lower than a melting temperature of a resin to be used and not higher than about 120° C., particularly preferable about 90° C. to 110° C. When the melting and kneading temperature is 120° C. or lower, there is a tendency that “fish eye” of the resulting adhesive film is reduced, being preferable.

A thickness of the present adhesive film obtained by extrusion molding is usually about 5 μm to about 2 mm, preferably 8 μm to 1 mm.

Examples of the support substrate include a polyolefin film such as a film composed of a 4-methyl-1-pentene copolymer, a cellulose acetate film, a releasing paper in which a silicone releasing agent or a fluorine releasing agent is coated on side in contact with a layer composed of a thermosetting resin composition, and a releasing polyethylene terephthalate (PET) film.

Then, the present adhesive described in (IV) and (V) exemplifying the aforementioned process for preparing the present adhesive film will be explained.

The present adhesive contains the present composition and an organic solvent and/or water (hereinafter referred to as (D) component). Herein, examples of the organic solvent include aromatic hydrocarbons such as toluene and xylene, esters such as ethyl acetate and butyl acetate, ketones such as acetone, methyl ethyl ketone, and methyl isobutyl ketone, alcohols such as methanol and butanol, chlorinated hydrocarbons such as methylene chloride, and aliphatic hydrocarbons such as hexane, heptane, petroleum ether.

The (D) component may be a mixture of two or more kinds of components.

When the (D) component is an organic solvent, aromatic hydrocarbons and ketones are preferably used.

When water is used as the (D) component, in order to disperse the (A) component and the (B) component to improve storage stability as a thermosetting resin composition, it is preferable to use an emulsification dispersing agent such as partially saponified polyvinyl alcohol, completely saponified polyvinyl alcohol, and polyethylene glycol in combination therewith.

Examples of the process for preparing the present adhesive include a method of dissolving or dispersing (A) component and the (B) component in the (D) component, respectively, followed by mixing, a method of dissolving or dispersing both of the (A) component and the (B) component in the (D) component, and a method of preparing an aqueous emulsion of the (A) component and/or the (B) component by emulsion polymerization, and preparing a mixture of emulsified aqueous solutions of the (A) component and the (B) component.

The present adhesive may contain additives such as an inorganic filler, a pigment, a processing stabilizing agent, a weather resistant agent, a thermal stabilizing agent, an optical stabilizing agent, a nucleating agent, a lubricant, a releasing agent, a flame-retardant, and an antistatic agent in addition to the (C) component. When the present composition contains an inorganic filler, a content of the inorganic filler is preferably 70 parts by weight or smaller relative to a total 100 parts by weight of the (A) component and the (B) component.

A molecular weight of each of the (A) component and the (B) component used in the present adhesive is usually such a molecular weight that the adhesive can be uniformly dissolved, and a coatable viscosity is given.

There is a tendency that when a thickness of the present adhesive film obtained by coating and drying the present adhesive is about 3 μm or larger, adherability is excellent, and the thickness is preferably about from 3 to about 100 μm, particularly preferably about from 3 to about 50 μm.

A total weight of the (A) component and the (B) component in the present adhesive is usually 10 to 150 parts by weight relative to 100 parts by weight of the (D) component. There is a tendency that when a total of the (A) and (B) components is 10 parts by weight or larger, coatability to the present composition on a support substrate is excellent. There is a tendency that when a total of (A) component and the (B) component is 150 parts by weight or smaller, a viscosity of a composition composed of the (A) component, the (B) component and the (D) component is reduced, and coatability upon coating of the present adhesive on a support substrate is excellent, being preferably.

More specific examples of a process for preparing the present adhesive film using the present adhesive include a method of coating with a roll coater and a blade coater such as a reverse roll coater, a gravure coater, a microbar coater, a kiss coater, a Meyer bar coater, and an air knife coater, and allowing to stand this, or drying this with a heat ventilating oven or the like.

Inter alia, since when the present adhesive film is prepared using a roll coater, a thickness of a film can be easily controlled from a thin film to a thick film, being preferable.

In preparation of a laminate obtained by laminating the present adhesive film and an adherent and thermally curing this, by irradiating the present adhesive film with an electron beam before lamination of the present adhesive film and the adherent or after lamination and before thermal curing, squeeze-out of the adherent due to flowing out of the resin component derived form the present adhesive film at thermal curing can be prevented, being preferable. When electron beam irradiation is performed after lamination of the adherent and the present adhesive film and before thermal curing, heat resistance of the present adhesive film can be improved in addition to the aforementioned effect of preventing squeeze-out of a resin, being more recommendable.

An electron beam to be used is a bundle of electrons accelerated with a voltage, and is classified into low energy-type electron beam to be accelerated with a voltage of around 50 to 300 kV, intermediate energy-type electron beam to be accelerated with a voltage of around 300 to 5000 kV, and high energy-type electron beam to be accelerated with a voltage of around 5000 to 10000 kV. When applied to the present invention, a low energy-type electron beam is usually used.

Examples of an electron accelerator include a linear cathode type, a module cathode type, a thin plate cathode type, and a low energy scanning type.

Examples of a method of irradiating an electron beam include a method of irradiating only one side not covered with a support substrate of a laminate composed of the present adhesive film obtained by extrusion molding and a support substrate with an electron beam under inert gas atmosphere such as nitrogen; a method of irradiating a side covered with a support substrate of the laminate with an electron beam; a method of peeling a support substrate from the laminate, and irradiating one side or both sides of the present adhesive film with an electron beam; a method of peeling a support substrate from the laminate, laminating on an adherent described below in advance, and irradiating this with an electron beam.

A desired electron beam dose may be irradiated once. However, when an electron beam of around 80 kGy or larger is irradiated, it is preferable to irradiate an electron beam plural times, for example, about two times in order to retain appearance of the adhesive film after electron beam irradiation, or increase a crosslinking density of the adhesive film by electron beam irradiation.

A total irradiation dose of an electron beam is usually around 10 to 300 kGy, preferably around 50 to 250 kGy. There is a tendency that when an irradiation dose is 10 kGy or larger, effect of opacifying a surface of an adherent upon rolling of a film at thermal adhesion and thermal curing is improved, being preferable. There is a tendency that, when the dose is 300 kGy or smaller, the adhesive film is embedded in conformity with irregularities of an adherent, and adherability is improved, being preferable.

The laminate of the present invention (hereinafter, referred to as present laminate) is a laminate such that the present adhesive film is laminated with an adherent and thermally cured. It is preferable to irradiate the present adhesive film with an electron beam in advance before thermal curing (before or after lamination on an adherent) as described above.

As the adherend, different two or more kinds of adherends may be used.

A process for preparing the present laminate will be explained referring to the present adhesive film on which a support substrate is laminated as an example, and examples of the process include a method of peeling a support substrate from the present adhesive film, laminating an adherend on both sides or one side of the present adhesive film, and thermally curing this, a method of laminating an adherend on a side of the present adhesive film on which a support substrate is not laminated, peeling a support substrate from the adhesive film and, if necessary, laminating an adherend different from the adherend on a side from which a support substrate has been peeled, and thermally curing this; and a method of laminating a side of the present adhesive film on which a support substrate is not laminated, with an adherend, thermally curing this, and peeling a support substrate from the adhesive film.

Examples of thermal curing condition for preparing the present laminate include condition of retaining at about 100° C. to about 350° C., preferably about 120 to about 300° C., particularly preferably about 160 to about 200° C. for about 10 minutes to around 3 hours. There is a tendency that, when a retaining temperature is 100° C. or higher, a thermal curing time until solder heat resistance is obtained is shortened, being preferable. On the other hand, when the temperature is 350° C. or lower, thermal degradation of the present adhesive film is small, being preferable.

In addition, upon thermal curing, pressurization may be performed at 0 to 6 MPa using a heatable press machine.

Examples of a material for adherend used in the present laminate include materials which can be adhered with the present adhesive film. Specific examples include inorganic materials such as metals such as gold, silver, copper, iron, tin, lead, aluminum and silicon, glasses, and ceramics; and synthetic polymer materials such as cellulose polymer materials such as a paper and a cloth, melamine resins, acryl-urethane resins, urethane resins, a (meth)acryl resin, styrene-acrylonitrile copolymers, polycarbonate resins, phenol resins, alkyd resins, epoxy resins, and silicone resins.

A material for the adherend may be a mixture or a composite material composed of two or more kinds of materials. When the present laminate is such that different two adherends are adhered via the present adhesive film, materials constituting two adherends may be the same kind material or a different kinds of materials.

A nature of the adherend is not particularly limited, but examples include film-like, sheet-like, plate-like, and fiber-like forms.

In addition, if necessary, the adherend may be subjected to surface treatment such as releasing agent treatment, covering treatment such as plating, coating treatment with a paint containing a resin component other than the present composition, surface modifying treatment with plasma or laser, surface oxidizing treatment, and etching.

As the adherend, electric or electronic parts such as an integrated circuit and a printed circuit board which are a composite material of a synthetic polymer material and a metal are preferably used.

The following Examples further illustrate the invention in detail, but the present invention is not limited by them.

As (A), (B) and (D) components, the following were used. MFR (melt flow rate) shows a value measured under condition of 190° C. and 2160 g load according to JIS-K7210.

### (A) Component

A-1: “Tackrol 101” manufactured by Taoka Chemical Co., Ltd.

Alkylphenol novolak resin containing a structural unit derived from alkylphenol of a carbon number of 11 as a main component

A-2: “Tamanol 7508” manufactured Arakawa Chemical Industries, Ltd.

### Alkylphenol Novolak Resin

A-3: “PP-700-MX60 manufactured by Nippon Petrochemicals Co., Ltd.

### Phenol Adduct of Liquid Polybutadiene

60% by weight xylene/methyl ethyl ketone solution

A-4: “Tamanol 759” manufactured by Arakawa Chemical Industries, Ltd.

### Phenol Novolak Resin Not Substituted with an Alkyl Group

A-5: “PP-700-300” manufactured by Nippon Petrochemicals Co., Ltd.

### Phenol Adduct of Liquid Polybutadiene

### (B) Component

B-1: Ethylene-methyl acrylate-glycidyl methacrylate copolymer manufactured by Sumitomo Chemical Co., Ltd.

Content of structural unit derived from glycidyl methacrylate: 5.4% by weight

Content of structural unit derived from methyl acrylate: 26.9% by weight (MFR=253 g/10 min)

B-2: Ethylene-methyl acrylate-glycidyl methacrylate copolymer manufactured by Sumitomo Chemical Co., Ltd.

Content of structural unit derived from glycidyl methacrylate: 11.2% by weight

Content of a structural unit derived from methyl acrylate: 26.2% by weight (MFR=230 g/10 min)

B-3: Ethylene-glycidyl methacrylate copolymer manufactured by Sumitomo Chemical Co., Ltd.

Content of a structural unit derived from glycidyl methacrylate: 18.0% by weight (MFR=350 g/lOmin)

### (C) Component

C-1: β-(3,5-di-t-butyl-4-hydroxyphenyl)propionic acid stearyl ester

### Phenolic antioxidant, Irganox 1076 Manufactured by Ciba Specialty Chemicals

C-2: tris(2,4-di-t-butylphenyl) phosphate

### Phosphoric antioxidant, Irgafos 168 Manufactured by Ciba Specialty Chemicals

C-3: Pentaerythryltetrakis-3-lauryl thiopropionate

### (Sulfuric Antioxidant, Sumilizer TP-D Manufactured by Sumitomo Chemical Co., Ltd.)

### (E) Component: Curing Promoter

E-1: “Curesol 2E4MZ” manufactured by Shikoku Corp. 2-ethyl-4-methylimidazole

### EXAMPLES 1 TO 11 AND COMPARATIVE EXAMPLE 1

Example of preparation of an adhesive film obtained by preparing an adhesive, coating the adhesive on a support substrate, and drying this.

### (1) Preparation of (A) Component-Containing Solution (Mixture of (A) Component and (D) Component)

### Preparation of (A-1) Solution

20 Parts by weight of (A-i) component and 80 parts by weight of toluene were taken in a flask, and stirred and dissolved for 1 hour while maintaining at 80° C., to obtain a toluene solution containing 20% by weight of (A-1) component.

### Preparation of (A-2) Solution

20 Parts by weight of (A-2) component and 80 parts by weight of acetone were taken in a flask, and stirred and dissolved for 1 hour while maintaining at 80° C., to obtain an acetone solution containing 20 % by weight of (A-2) component.

### Preparation of (A-3) Solution

20 parts by weight (A-3) component and 80 parts by weight of methyl ethyl ketone were taken in a flask, and stirred and dissolved for 1 hour while maintaining at 80° C., to obtain a methyl ethyl ketone solution containing 20% by weight of (A-3) component.

### Preparation of (A-4) Solution

A commercially available xylene/methyl ethyl ketone solution containing 60% byweight of (A-4) component, PP-700-MX60 was used.

### (2) Preparation of (B) Component-Containing Solution (Mixture of (B) Component and (D) Component)

### Preparation of (B-1) Solution

30 Parts by weight of (B-1) component and 70 parts by weight of toluene were taken in a flask, and stirred and dissolved for 1 hour while maintaining at 80° C., to obtain a toluene solution containing 30% by weight of (B) component.

### <Preparation of (B-2) Solution>

30 Parts by weight of (B) component and 70 parts by weight toluene were taken in a flask, and stirred and dissolved for 1 hour while maintaining at 80° C., to obtain a toluene solution containing 30% by weight of (B) component.

### (3) Preparation of (E) Component-Containing Solution (Mixture of (E) Component and (D) Component)

### <Preparation of (E-1) Solution>

20 Parts by weight of (E-1) component and 80 parts by weight of toluene were taken in a flask, and stirred and dissolved for 1 hour while maintaining at 80° C., to obtain a toluene solution containing 20 % by weight of (E-1) component.

### (4) Preparation of Adhesive

The thus obtained (A) component ([A-1 to A-4]) dissolved in (D) component, (B) component ([B-1 to B-2]) dissolved in (D) component and (E) component ([E-1]) dissolved in (D) component (mixing rate (solid matter, part by weight) described in Tables 1 to 3) were stirred and mixed at room temperature for 10 minutes to obtain an adhesive. A mixing ratio (solid matter, part by weight) represents a weight ratio of only (A) component, (B) component and (E) component, and a weight ratio of (D) component is not reflected. In addition, a mixing ratio (%) represents a weight percentage of respective components of (A) to (E) including (D) component.

### (5) Preparation Example 1 of Adhesive Film (Before Adhesion)

The adhesive obtained by the above (4) was coated on a releasing-treated side of a releasing polyethylene terephthalate (PET) film (“FF-50” manufactured by Unitika Ltd. one side releasing-treated PET film, thickness support substrate 50 μm) as a support substrate using a Meyer bar coater, and dried for 3 minutes in an oven at 90° C. to obtain an adhesive film composed of two layers of a supporting substrate and an adhesive layer. By adjusting an amount of an adhesive to be coated, three kinds of bilayered adhesive films having a thickness of an adhesive layer of 4 μm, 8 μm and 20 μm were prepared.

### (6) Preparation Example 2 of Adhesive Film (Before Adhesion)

The adhesive obtained by the above (4) was coated on one side of a polyethylene terephthalate (PET) film (“DIAFOILT600E50 W07” manufactured by Mitsubishi Chemical Corp., both sides-coated PET film, thickness of support substrate of 50 μm) as a support substrate using a Meyer bar coater, and dried for 3 minutes in an oven at 90° C. to obtain an adhesive film composed of two layers of a PET film and an adhesive layer. By adjusting an amount of an adhesive to be coated, three kinds of bilayered adhesive films having a thickness of an adhesive layer of 4 μm, 8 μm and 20 μm were prepared.

### (7) Film Processability

Appearance of an adhesive film layer of the bilayered adhesive films obtained in the above (5) and (6) was observed with naked eyes. The results are summarized in Table 1 to 3.

Determination of adhesive film appearance observation was according to the following criteria:
\mathring{O}: Film layer having thickness of 20 μm is transparent.
◯: Film layer having thickness of 8 μm is transparent, and film layer having a thickness of 20 μm is opaque.
Δ: Film layer having thickness of 4 μm is transparent, and film layer having thickness of 8 μm is opaque.
x: Adhesive film layer having thickness of 4 μm is opaque.

### (8) Preparation Example 1 of Laminate and Solder Heat Resistance Test

A side of an adhesive film layer of the bilayered adhesive film having a thickness of an adhesive layer of 20 μm obtained by the above (5) and a side of a wiring pattern of a printed circuit board (one side copper-clad laminated plate R-1705(FR4 printed circuit board) manufactured by Matsushita Electric Works, Ltd.) were laminated, and thermally pressed at upper and lower roll temperatures of 100° C. under condition of a linear pressure of 14.5 kg/cm and a speed of 0.5 m/min using a laminator (“First Laminator VA-700” manufactured by Taisei laminator Co., Ltd.). Subsequently, this was thermally pressed at 100° C. for 10 minutes under condition of 2 MPa using a heat press. Further, this was thermally cured at 180° C. for 60 minutes under condition of 2 MPa using a heat press, and a releasing PET film on a surface of the laminate was peeled to obtain a laminate.

### <Solder Heat Resistance Test>

The resulting laminate was immersed in a solder bath at 260° C. for 10 seconds using SOLDERABILITY TESTER EST-11 manufactured by Tabai Espec Corp. Letting this to be one cycle, 6 cycles were repeated, and appearance of the surface was observed with naked eyes. The results are summarized in Tables 1 to 3.

Determination of a solder heat resistance test was according to the following criteria:
◯: No abnormality (peeling, dilation) was observed in appearance of a thermally cured adhesive layer, and no solder grain is observed.
x: Abnormality (peeling, dilation) is observed in appearance of the thermally cured adhesive layer, or solder grain is observed.

### (9) Preparation Example 2 of Laminate and Peeling Test

A side of an adhesive film layer of the bilayered adhesive film of 20 μm obtained in the above (6), a copper foil with a resin and a side of a non-wiring pattern of a printed circuit board (one side copper-clad laminate plate R-1705 (FR4 printed circuit plate) manufactured by Matsushita Electric Works, Ltd.) were laminated, and heat-sealed at 180° C. and a pressure of 0.1 MPa (gauge pressure) for 60 minutes from upper and lower bars using a heat seal tester (“Heat Seal Tester TP-701-B” manufactured by Tester Sangyo Co., Ltd.) to obtain a laminate. The resulting laminate was conditioned for 1 hour under condition of a temperature of 23° C. and a relative humidity of 50%, a test piece of 10 mm width×100 mm length (adhesion length 25 mm) was excised from the laminate, and a peeling test was performed at a peeling speed of 50 mm/sec and a peeling angle of 90° under condition of temperature of 23° C. and a relative humidity of 50%. The results are summarized in Tables 1 to 3.

TABLE 1

| | | Example | | | |
|---|---|---|---|---|---|
| | | 1 | 2 | 3 | 4 |
| Mixing | A-1 (Parts) | 4 | 6 | 8 | — |
| ratio | A-2 (Parts) | — | — | — | 8.8 |
| (weight) | A-3 (Parts) | — | — | — | — |
| | A-4 (Parts) | — | — | — | — |
| | B-1 (Parts) | 100 | 100 | 100 | 100 |
| | B-2 (Parts) | — | — | — | — |
| | E-1 (Parts) | — | — | — | 0.08 |
| Mixing | (A) Component | 1.1 | 1.7 | 2.1 | 2.3 |
| ratio | (B) Component | 28.3 | 27.5 | 26.8 | 26.5 |
| (%) | (D) Component | 70.6 | 70.8 | 71.2 | 71.2 |
| | (E) Component | — | — | — | 0.0 |
| Peeling | Resin-clad copper | 4.4 | 4.4 | 12.3 | 11.9 |
| test | foil | | | | |
| | FR4(N/10 mm) | 14.1 | 13.3 | 16.4 | 12.3 |

| | | | | |
|---|---|---|---|---|
| Solder heat resistance test | ◯ | ◯ | ◯ | ◯ |
| Film processability | ⊚ | ⊚ | ⊚ | ⊚ |

TABLE 2

| | | Example | | | |
|---|---|---|---|---|---|
| | | 5 | 6 | 7 | 8 |
| Mixing | A-1 (Parts) | — | — | — | — |
| ratio | A-2 (Parts) | — | — | — | — |
| (weight) | A-3 (Parts) | 18.8 | 18.8 | 25 | 31.3 |
| | A-4 (Parts) | — | — | — | — |
| | B-1 (Parts) | 100 | 100 | 100 | 100 |
| | B-2 (Parts) | — | — | — | — |
| | E-1 (Parts) | — | 1.88 | — | — |
| Mixing | (A) Component | 5.2 | 5.0 | 6.7 | 8.1 |
| ratio | (B) Component | 27.4 | 26.7 | 26.7 | 25.9 |
| (%) | (D) Component | 67.4 | 67.7 | 66.7 | 65.9 |
| | (E) Component | — | 0.5 | — | — |
| Peeling | Resin-clad copper | 9.6 | 6.9 | 29.4 | 37.9 |
| Test | foil (N/10 mm) | | | | |
| | FR4(N/10 mm) | 10.3 | 9.2 | 41.0 | 41.9 |

| | | | | |
|---|---|---|---|---|
| Solder heat resistance test | ◯ | ◯ | ◯ | ◯ |
| Film processability | ⊚ | ⊚ | ⊚ | ⊚ |

TABLE 3

| | | | | | Comparative |
|---|---|---|---|---|---|
| | | Example | | | Example |
| | | 9 | 10 | 11 | 1 |
| Mixing | A-1 (Parts) | — | — | — | — |
| ratio | A-2 (Parts) | — | — | — | — |
| (weight) | A-3 (Parts) | 12.5 | 18.8 | 25 | — |
| | A-4 (Parts) | — | — | — | 5 |
| | B-1 (Parts) | — | — | — | 100 |
| | B-2 (Parts) | 100 | 100 | 100 | — |
| | E-1 (Parts) | — | — | — | — |
| Mixing | (A) Component | 3.5 | 5.2 | 6.7 | 1.4 |
| ratio | (B) Component | 28.2 | 27.4 | 26.7 | 27.9 |
| (%) | (D) Component | 67.2 | 67.4 | 66.7 | 70.7 |
| | (E) Component | — | — | — | — |
| Peeling | Resin-clad copper | 5.4 | 7.1 | 7.0 | 13.0 |
| test | foil (N/10 mm) | | | | |
| | FR4(N/10 mm) | 12.0 | 12.3 | 11.9 | 15.4 |

| | | | | |
|---|---|---|---|---|
| Solder heat resistance test | ◯ | ◯ | ◯ | X |
| Film Processability | ⊚ | ⊚ | ⊚ | X |

### EXAMPLES 12 TO 14

### Preparation Example of Adhesive film Obtained by Extruding and Molding Present Composition

### (1) <Preparation Example 1>

B-3 (100 parts), C-1 (0.1 part), C-2 (0.1 part) and C-3 (0.05 part) were dry-blended, supplied to a corotating biaxial extruder (L/D=42) of φ30 mm, and melted and kneaded under a temperature of 120° C. at a screw rotation number of 180 rpm and a supply rate of 16 Kg/hour to obtain the material, and 95 parts of the material and 5 parts of A-1 were dry blended to obtain a thermosetting resin composition. Subsequently, an extruder equipped with a T-die of a laboplastmill φ20mm manufactured by Toyo Seiki Co., Ltd. was used, and a temperature of an extruder cylinder was set at 100° C., a temperature of a T-die was set at 90° C., and an air gap was set at 2cm. The aforementioned thermosetting resin composition and aforementioned extruder were used to prepare an adhesive film having a thickness of about 50 μm.

### (2) <Preparation Example 2>

B-1 (100 parts), C-1 (0.1 part), C-2 (0.1 part), C-3 (0.05 part), and A-5 (10 parts) which had been ground with a feather mill and a Nara-type grinder (three times) were dry-blended, fed to a corotating biaxial extruder (L/D=42) of φ30 mm, and melted and kneaded under a temperature of 120° C. at a screw rotation number of 180 rpm and a supply speed of 16 Kg/hour to obtain a thermosetting resin composition. Subsequently, a laboplastmill φ20 mm extruder equipped with a T-die manufactured by Toyo Seiki Co., Ltd. was used, an extruder cylinder temperature was set at 100° C., a T-die temperature was set at 90° C., and an air gap was set at 2 cm. The thermosetting resin composition and the extruder were used to prepare an adhesive film having a thickness of about 50 μm.

### (3) <Preparation Example 3>

According to the same conditions as those of Preparation Example 2 except that an amount of A-5 was 25 parts, an adhesive film having a thickness of about 50 μm was prepared.

### Preparation Example of Laminate Obtained from Adhesive Film Obtained by Extrusion Molding, and Peeling Test

An aluminum foil, a reinforcing material (polyethylene terephthalate film having a thickness of 50 μm), the adhesive film obtained in Preparation Examples 1 to 3, an adherend (side of non-wiring pattern of copper foil-clad substrate and printed circuit board (one side copper-clad laminate plate R-1705 (FR4 printed circuit board) manufactured by Matsushita Electric Works, Ltd.)) and an aluminum foil were successively layered in this order from an upper side, and a part (25 mm width) of the laminate was adhered by retaining at 180° C. and a pressure of 0.5 MPa from an upper side for 60 minutes with a heat seal tester (manufactured by Tester Sangyo Co., Ltd.) to obtain the laminate of the present invention.

An aluminum foil of the resulting laminate was peeled, and allowed to stand for 1 hour at a temperature of 23° C. and a humidity of 50%. Thereafter, the laminate was excised into 10 mm width×100 mm length (adhesion length 25 mm ), an unadhered part was grasped at a temperature of 23° C. and a humidity of 50%, and apeeling test was performed at apeeling rate of 50 mm/sec and a peeling angle of 90°.

In addition, the laminate prepared according to the same manner was subjected to a solder heat resistance test as described above.

The results are shown in Table 4.

TABLE 4

| | | Example | | |
|---|---|---|---|---|
| | | 12 | 13 | 14 |
| Mixing | A-1 (Parts) | 5 | — | — |
| ratio | A-5 (Parts) | — | 10 | 25 |
| | B-3 (Parts) | 95 | 100 | 100 |
| | C-1 (Parts) | 0.095 | 0.1 | 0.1 |
| | C-2 (Parts) | 0.095 | 0.1 | 0.1 |
| | C-3 (Parts) | 0.0475 | 0.05 | 0.05 |
| Peeling | Resin-clad copper | 15.3 | 14.5 | 11.9 |
| test | foil (N/10 mm) | | | |
| | FR4 substrate | 19.0 | 18.6 | 17.9 |
| | (N/10 mm) | | | |

| | | | |
|---|---|---|---|
| Solder heat resistance test | ◯ | ◯ | ◯ |
| Film processability | ⊚ | ⊚ | ⊚ |

### EXAMPLE 15

### (1) <Preparation Example of Adhesive Film Obtained by Extrusion Molding on Support Substrate>

A cylinder temperature of an extruder equipped with a φ40 mm T-die having an air gap of 4 cm was set at 100° C., and a T-die temperature of the extruder was set at 90° C. Subsequently, B-1 (100 parts), C-1 (0.1 part), C-2 (0.1 part), C-3 (0.05 part) and A-2 (10 parts) which had been ground-with a feather mill and a Nara-type grinder (three times) were dry-blended, fed to a corotating biaxial extruder (L/D=42) of φ30 mm, and melted and kneaded under a temperature of 120° C. at a screw rotation number of 180 rpm and a supply speed of 16 Kg/hour to obtain a thermosetting resin composition. The composition was melted and kneaded with the extruder, and extruded and molded on a side of a polyethylene terephthalate film (SC-38 manufactured by Unitika Ltd.) on which a silicon releasing agent had been coated, to obtain an adhesive film composed of two layers of an adhesive film layer having a thickness of about 10 μm and a polyethylene terephthalate film layer (support substrate layer).

### (2) <Preparation Example of Laminate>

A printed circuit board (both sides copper—clad laminate plate R-1705 manufactured by Matsushita Electric Works, Ltd.) as an adherend was laminated on an adhesive film layer of the bilayered adhesive film obtained in the (1), this was thermally pressed under conditions of 100° C., 3 MPa and 10 minutes from an upper side of a support substrate, and thermally cured under conditions of 180° C., 3 MPa and 60 minutes to obtain a laminate. Subsequently, the resulting laminate was allowed to stand for 1 hour at a temperature of 23° C. and a humidity of 50%. Thereafter, the laminate was excised into 10 mm width×100 mm length, a support substrate layer was grasped at a temperature of 23° C. and a humidity of 50%, and a peeling test was performed at a peeling rate of 100 mm/sec and a peeling angle of 180°. The support substrate layer was peeled at a peeling strength of 0.01 N/cm or smaller, but the adhesive film layer could not be peeled. Separately, the laminate prepared as described above was subjected to a solder heat resistance test as described above, and abnormality (peeling, dilation) was not observed in appearance of the adhesive film layer.

### EXAMPLE 16

### Preparation Example of Adhesive Film Obtained by Extruding and Molding Present Composition and Irradiating Resulting Molded Article with an Electron Beam

### (1) <Preparation Example>

B-3 (100 parts), C-1(0.1 part), C-2(0.1 part) and C-3(0.05 part) were dry-blended, fed to a corotating biaxial extruder (L/D=42) of φ30 mm, melted and kneaded under a temperature of 120° C. at a screw rotation number of 180 rpm and a supply rate of 16 Kg/hour, 100 parts of the resulting material and 2.5 parts of A-5 were dry-blended, fed to a corotating biaxial extruder (L/D=42) of φ30 mm, and melted and kneaded under a temperature of 140° C. at a screw rotation number of 180 rpm and a supply rate of 16 Kg/hour to obtain a thermosetting resin composition. Then, by using a φ40 mm extruder equipped with a T-die, setting an extruder cylinder temperature at 100° C. and a T-die temperature at 90° C., and laminating the curing resin composition on a releasing PET film by melting extrusion, an adhesive film composed of two layers of an adhesive film layer (thickness 105 μm)/ releasing PET film layer (thickness 38 μm) was prepared.

Subsequently, a side of an adhesive film layer of the bilayered adhesive film was irradiated with a 100 kGy electron beam at an acceleration voltage of 200 kV using an electron beam irradiating apparatus having an acceleration voltage of 100 to 200 kV and an irradiation line width of 450 mm manufactured by Iwasaki Electric Co. Ltd., and second electron beam irradiation was performed again under the same condition to obtain an electron beam-treated bilayered adhesive film having a thickness of an adhesive film layer of 105 μm. This electron beam—treated bilayered adhesive film was subjected to preparation of a laminate.

### (2) Preparation Example 1 of Laminate and Peeling Test

Regarding the electron beam-treated bilayered film obtained in the (1), the adhesive film layer and a copper plate (JIS H 3100, tough pitch copper, thickness 0.5 mm) were laminated, and thermally pressed under conditions of upper and lower roll temperatures of 150° C., a linear pressure of 14.5 kg/cm and a rate of 0.5 m/min using a laminator (“First Laminator VA-700” manufactured by Taisei Laminator Co. Ltd.). Subsequently, a releasing PET film layer on a surface of the laminate was peeled, a polyimide film (Upilex S: thickness 50 μm manufactured by Ube Industries, Ltd. ) was laminated on an adhesive film layer side, and the polyimide film was thermally pressed for 10 seconds under 200° C. and a pressure of 0.5 MPa at a sealing width of 25 mm from an upper side and a lower side with a heat seal tester (manufactured by Tester Sangyo Co., Ltd). Further, the resulting laminate was thermally cured for 2 hours in an oven at 150° C. to obtain a laminate for a peeling test.

A peeling test piece having a width of 10 mm was excised from the resulting laminate, and 90 degree peeling was performed at a peeling rate of 50 mm/min. The results are shown in Table 5.

### (3) Preparation Example 2 of Laminate and Runoff Test

A circle test piece having a diameter of 6mm was punched from the electron beam-treated bilayered adhesive film obtained in (1), and releasing PET was peeled and removed. The resulting test piece was held between a glass slide (thickness 1.5 mm) and a copper plate (JISH3100, tough pitch copper, thickness 0.5 mm), and an initial diameter of a test piece was measured. The resulting value was adopted as a diameter before thermal pressing. The resulting laminate was thermally pressed for 10 seconds under 180° C. and a pressure of 0.5 MPa at a width of 25 mm from an upper side and a lower side with a heat seal tester (manufactured by Tester Sangyo Co. Ltd.), and a diameter of the resulting test piece was measured. The resulting value was adopted as a diameter after thermal pressing. From the resulting measured values, a runoff rate which is an index of easiness of squeeze-out of a resin component of an adhesive film from an adherend was calculated using the following equation (I), and low runoff as low as 18% was shown.

$$[ Runoff rate ( \% ) ] = \frac{\begin{matrix}[ diameter after thermal pressing ] - \\ [ diameter of before thermal pressing ]\end{matrix}}{[ diameter after thermal pressing ]} \times 100 [ I ]$$

### EXAMPLES 17 TO 22

According to the same manner as that of Example 16 except that an amount of (A) component (A-5) to be used, and a dose of an electron beam to be irradiated in Example 16 were as described in Table 5, the bilayered adhesive film and the laminate were prepared. Regarding the resulting laminate, a peeling test and a runoff test were performed as in Example 16. The results are summarized in Table 5 together with those of Example 16. In Example 22, electron beam irradiation was performed only one time.

TABLE 5

| | | Example | | | | | | |
|---|---|---|---|---|---|---|---|---|
| | | 16 | 17 | 18 | 19 | 20 | 21 | 22 |
| Mixing ratio | A-5 | 2.5 | 2.5 | 5 | 5 | 10 | 10 | 10 |
| (parts) | B-3 | 100 | 100 | 100 | 100 | 100 | 100 | 100 |
| | C-1 | 0.1 | 0.1 | 0.1 | 0.10 | 0.1 | 0.1 | 0.1 |
| | C-2 | 0.1 | 0.1 | 0.1 | 1 | 0.1 | 0.1 | 0.1 |
| | C-3 | 0.05 | 0.05 | 0.05 | 0.05 | 0.05 | 0.05 | 0.05 |
| Dose of | First | 100 | 110 | 100 | 110 | 100 | 110 | 200 |
| electron beam | time | | | | | | | |
| irradiation | (kGy) | | | | | | | |
| | Second | 100 | 110 | 100 | 110 | 100 | 110 | — |
| | time | | | | | | | |
| | (kGy) | | | | | | | |

| | | | | | | | |
|---|---|---|---|---|---|---|---|
| Peeling test (N/10 mm) | 14.6 | 20.3 | 11.3 | 9.2 | 4.9 | 3.8 | 4.2 |
| Film processability | ⊚ | ⊚ | ⊚ | ⊚ | ⊚ | ⊚ | ⊚ |
| Runoff rate (%) | 18 | 13 | 18 | 16 | 42 | 31 | 26 |

An adhesive comprising the thermosetting resin composition of the present invention and a solvent is excellent in coatability on a support substrate, operability, flowability and film processability.

In addition, the adhesive film of the present invention is excellent in adherability even at a thin film, and, further in the electron beam-irradiated adhesive film, runoff of a resin portion is remarkably suppressed upon thermal curing.

Further, when an adherend is laminated on any of these adhesive films, and thermally cured, a laminate which is excellent in adherability and solder heat resistance, and has an adhesive layer having a low elastic modulus is obtained.

By utilizing such the excellent property, the laminate of the present invention can be used in semiconductor sealing materials, electronic part sealing materials for solar cells and EL (electroluminescence) lamps, die bonding sheets between integrated circuit/substrate and interlayer insulating layers between substrates, and solder resists for printed circuit boards.

1. A thermosetting resin composition, which comprises the following (A) component and (B) component.
(A) component: at least one kind of phenol resin selected from the group consisting of alkylphenol novolak, a phenol adduct of an aliphatic polymer containing a double bond, and a phenol adduct of an alicyclic polymer containing a double bond
(B) component: epoxy group—containing ethylene copolymer obtained by polymerizing the following (b₁) and (b₂):
(b₁) ethylene and/or propylene
(b₂) monomer represented by the following formula (1): 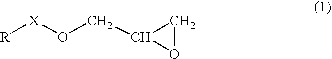
(wherein R represents a hydrocarbon group of a carbon number of from 2 to 18 having a double bond, wherein at least one of hydrogen atoms of the hydrocarbon group may be substituted with a halogen atom, a hydroxyl group or a carboxyl group, and X represents a single bond or a carbonyl group.)

2. The thermosetting resin composition according to claim 1, wherein the alkylphenol novolak is a condensate of formalin and phenol substituted with an alkyl group of a carbon number of from 2 to 20.

3. The thermosetting resin composition according to claim 1, wherein a content of a structural unit derived from (b₂) is from 1 to 30 parts by weight relative to 100 parts by weight of (B) component.

4. The thermosetting resin composition according to claim 1, wherein the (B) component is a copolymer obtained by polymerizing (b₁), (b₂) and the following (b₃):
(b₃): a monomer which has a functional group copolymerizable with ethylene, has no functional group reactive with an epoxy group, and is different from either of (b₁) and (b₂).

5. The thermosetting resin composition according to claim 1, wherein a content of a structural unit derived from (b₁) is from 30 to 75 parts by weight relative to 100 parts by weight of the (B) component.

6. The thermosetting resin composition according to claim 1, wherein a weight ratio of the (A) component and the (B) component is (A)/(B)=4/96 to 50/50.

7. The thermosetting resin composition according to claim 1, which further contains (C) component:
(C) component: antioxidant.

8. The thermosetting resin composition according to claim 7, wherein the (C) component is at least one of an antioxidant selected from the group consisting of a phenolic antioxidant, a phosphoric antioxidant and a sulfuric antioxidant.

9. An adhesive, which contains the thermosetting resin composition as defined in claim 1 and the following (D) component:
(D): organic solvent and/or water.

10. The adhesive according to claim 9, wherein a total weight of the (A) component and the (B) component is from 10 to 150 parts by weight relative to 100 parts by weight of the (D) component.

11. An adhesive film, which contains the thermosetting resin composition as defined in claim 1.

12. An adhesive film, which is obtained by coating the adhesive as defined in claim 9 on a support substrate, and drying this.

13. The adhesive film according to claim 11, which is obtained by extrusion molding.

14. An adhesive film, which is obtainable by further irradiating the adhesive film as defined in claim 11 with an electron beam.

15. The adhesive film according to claim 14, which is obtainable by performing electron beam irradiation plural times.

16. A laminate, which is obtainable by laminating the adhesive film as defined in claim 11 or 14 and an adherend, and thermally curing this.
